(19) United States
(12) Patent Application Publication
(10) Pub. No.: US 2019/0187790 A1
(43) Pub. Date: Jun. 20, 2019

(54) VEHICLE DISPLAY DEVICE AND CONTROL METHOD THEREOF

(71) Applicant: SAMSUNG ELECTRONICS CO., LTD., Suwon-si (KR)

(72) Inventors: Ji-hwan WOO, Seoul (KR); Young-yoon LEE, Suwon-si (KR); Won-hee CHOE, Seoul (KR); Se-hoon KIM, Suwon-si (KR); Seung-heon LEE, Suwon-si (KR); Kang-jin YOON, Seoul (KR); Hae-in CHUN, Suwon-si (KR)

(73) Assignee: SAMSUNG ELECTRONICS CO., LTD., Suwon-si (KR)

(21) Appl. No.: 16/323,178

(22) PCT Filed: Aug. 7, 2017
(86) PCT No.: PCT/KR2017/008488

§ 371 Date: Feb. 4, 2019

(30) Foreign Application Priority Data
Aug. 5, 2016 (KR) 10-2016-0099866

(51) Int. Cl. G06F 3/01; B60K 35/00; G06T 19/00

(52) U.S. Cl. CPC G06F 3/013; B60K 35/00; G06T 19/006; G06T 2219/004; B60K 2350/901; B60K 2350/1096; B60K 2350/2017; B60K 2350/352; B60K 2350/1072

(57) ABSTRACT

A vehicle display device and a control method thereof are provided. The present vehicle display device comprises: a camera for photographing a driver; a sensing unit for measuring the distance to an external object; a display for providing operating information of a vehicle; and a processor, which analyzes an image captured through a camera so as to track a driver's gaze, determines an external object present at the location at which the tracked driver's gaze is directed, calculates the distance to the determined object through the sensing unit, and controls the display such that the operating information is displayed on the basis of the driver's gaze and the distance to the object.

### TECHNICAL FIELD

The present disclosure relates to a vehicle display device and a control method thereof, and more particularly, to a vehicle display device that tracks a line of sight of a driver to provide driving information of a vehicle in a direction that the driver is looking at.

### BACKGROUND ART

Currently, many electronic devices are employed in automobiles, and importance of the electronic devices is also increasing. In particular, a vehicle display device (e.g., a head-up display device), which is one of the electronic devices of the automobiles, may be utilized for various functions such as a navigation function, an entertainment function, and the like, and importance thereof is gradually increasing.

A conventional vehicle display device provides driving information at a fixed position or depth. Therefore, in order to view the driving information at the fixed position and depth while looking at an object located in the front of the driver, it is necessary for the driver to move a line of sight. In this case, visibility of the driver is reduced due to a change in a focus of the line of sight of the driver, thereby increasing a risk and increasing sensitivity to motion sickness.

In addition, the convention vehicle display device displays only the driving information (e.g., a current speed, a speed of a preceding vehicle, and the like) of fixed contents at the fixed position. That is, there is a disadvantage that the conventional vehicle display device does not provide information that is actually necessary to the driver by providing only the fixed contents regardless of the object that the driver is currently looking at.

### DISCLOSURE

### Technical Problem

An object of the present disclosure provides a vehicle display device capable of providing driving information on an object that a driver is looking at to a position corresponding to a line of sight of the driver based on the line of sight of the driver, and a control method thereof.

### Technical Solution

According to an aspect of the present disclosure, a vehicle display device includes: a camera configured to capture a driver; a sensing unit configured to measure a distance from an external object; a display configured to provide driving information of a vehicle; and a processor configured to analyze an image captured by the camera to track a line of sight of the driver, determine the external object existing at a position to which the tracked line of sight of the driver is directed, calculate a distance from the determined object using the sensing unit, and control the display to display the driving information based on the line of sight of the driver and the distance from the object.

According to another aspect of the present disclosure, a control method of a vehicle display device includes: analyzing an image captured by the camera and tracking a line of sight of the driver; determining an external object existing at a position to which the line of sight of the driver is directed; calculating a distance from the determined object using a sensor; and displaying driving information of a vehicle based on the line of sight of the driver and the distance from the object.

### Advantageous Effects

According to the various embodiments of the present disclosure as described above, not only the driver may confirm the driving information safely, but also the sensitivity to motion sickness may be reduced by displaying the information on the object that the driver is looking at to a place at which the line of sight of the driver is staying according to the line of sight of the driver. In addition, the driver may obtain the necessary information on the object the driver is looking at.

### DESCRIPTION OF DRAWINGS

FIG. 1 is a diagram illustrating a vehicle system in which a vehicle display device according to an embodiment of the present disclosure is mounted;

FIG. 2 is a block diagram schematically illustrating a configuration of the vehicle display device according to an embodiment of the present disclosure;

FIG. 3 is a block diagram illustrating the configuration of the vehicle display device according to an embodiment of the present disclosure in detail;

FIGS. 4A to 4C are diagrams for describing a display capable of displaying a three-dimensional (3D) image of a glassless mode according to an embodiment of the present disclosure;

FIG. 5 is a flowchart for describing a control method of a vehicle display device according to an embodiment of the present disclosure in detail;

FIG. 6 is a diagram illustrating a camera for tracking a line of sight according to an embodiment of the present disclosure;

FIG. 7 is a diagram for describing a region of restoring the 3D image according to a line of sight of a driver according to an embodiment of the present disclosure;

FIGS. 8A to 8C are diagrams for describing examples in which a display region of driving information is determined according to a position of the line of sight of the driver, according to an embodiment of the present disclosure;

FIG. 9 is a diagram for describing an example in which a depth of the driving information is changed, according to an embodiment of the present disclosure;

FIGS. 10A to 10C are diagrams for describing examples in which an image is tilted according to the line of sight of the driver, according to various embodiments of the present disclosure;

FIGS. 11A to 11C are diagrams for describing examples in which an image is tilted or moved according to a position of the line of sight of the driver, according to various embodiments of the present disclosure;

FIG. 12 is a diagram for describing various types of driving information according to an embodiment of the present disclosure; and

FIG. 13 is a flow chart for describing a control method of a vehicle display device according to an embodiment of the present disclosure.

### BEST MODE

After terms used in the present specification are briefly described, the present disclosure will be described in detail.

General terms that are currently widely used were selected as terms used in embodiments of the present disclosure in consideration of functions in the present disclosure, but may be changed depending on the intention of those skilled in the art or a judicial precedent, the emergence of a new technique, and the like.

In the embodiments of the present disclosure, a ‘module’ or a ‘˜er/˜or’ may perform at least one function or operation, and be implemented by hardware or software or be implemented by a combination of hardware and software. In addition, a plurality of ‘modules’ or a plurality of ‘˜ers/˜ors’ may be integrated in at least one module and be implemented by at least one processor (not illustrated) except for a ‘module’ or a ‘˜er/or’ that needs to be implemented by specific hardware.

The expression such as “comprise” or “may comprise” that may be used in various embodiments of the present disclosure refers to the presence of the disclosed corresponding function, operation, or component, and does not limit one or more additional functions, operations, or components. Further, it will be further understood that the terms “comprises” or “have” used in various embodiments of the present disclosure specify the presence of stated features, steps, operations, components, parts mentioned in this specification, or a combination thereof, but do not preclude the presence or addition of one or more other features, numerals, steps, operations, components, parts, or a combination thereof.

The expression such as “or” in the various embodiments of the present disclosure includes any and all combinations of words listed together. For example, “A or B” may include A, B, or both A and B.

The expressions such as “first”, “second”, and the like used in various embodiments of the present disclosure may denote various components in various embodiments, but do not limit the corresponding components. For example, the above expressions do not limit the order and/or importance of the corresponding components. The expressions may be used to distinguish one component from another component. For example, a first driver device and a second driver device are both driver devices and represent different driver devices. For example, a first component may be named a second component and the second component may also be similarly named the first component, without departing from the scope of various embodiments of the present disclosure.

It is to be understood that when one component is referred to as being “connected to” or “coupled to” another component in various embodiments of the present disclosure, one component may be connected directly to or coupled directly to another component, but may be connected to or coupled to another component while having the other component intervening therebetween. On the other hand, it is to be understood that when one component is referred to as being “connected directly to” or “coupled directly to” another component, one component may be connected to or coupled to another component without the new other component intervening therebetween.

Terms used in various embodiments of the present disclosure are used only in order to describe specific embodiments rather than limiting various embodiments of the present disclosure. Singular forms are intended to include plural forms unless the context clearly indicates otherwise.

Unless being defined otherwise in various embodiments of the present disclosure, it is to be understood that all the terms used in the present specification including technical and scientific terms have the same meanings as those that are generally understood by those skilled in the art. Terms generally used and defined by a dictionary should be interpreted as having the same meanings as meanings within a context of the related art and should not be interpreted as having ideal or excessively formal meanings unless being clearly defined otherwise in various embodiments.

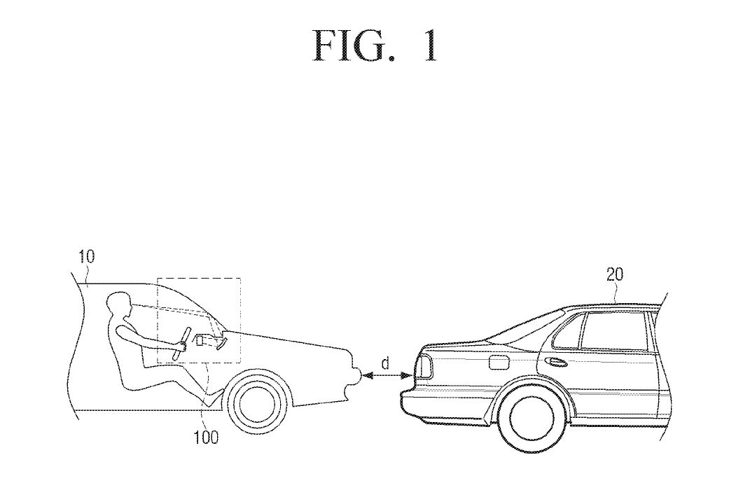

Hereinafter, the present disclosure will be described in more detail with reference to the drawings. FIG. 1 is a diagram illustrating a vehicle system 10 in which a vehicle display device 100 according to an embodiment of the present disclosure is mounted.

The vehicle display device 100 is mounted in the vehicle system 10, and provides driving information to a driver by using a windshield of the vehicle system 10.

In particular, the vehicle display device 100 may capture a driver by using a camera and analyze the captured image to track a line of sight of the driver.

In addition, the vehicle display device 100 may determine an external object existing at a position where the line of sight of the driver is directed based on the tracked line of sight of the driver. For example, as illustrated in FIG. 1, the vehicle display device 100 may determine that the object that the driver is looking at is an external vehicle 20 based on the line of sight of the driver.

In addition, the vehicle display device 100 may calculate a distance d from the external object by using a sensor. In this case, the vehicle display device 100 may calculate the distance from the external object by using an ultrasonic sensor.

In addition, the vehicle display device 100 may recognize the external object to obtain information (particularly, driving information) on the external object. Specifically, the vehicle display device 100 may obtain the information on the external object through an external server, and may obtain the information on the external object by searching for pre-stored information. In addition, the vehicle display device 100 may obtain the information on the external object by using various sensors (e.g., a senor for detecting a speed, and the like).

In addition, the vehicle display device 100 may process and display an image including the driving information based on the distance from the external object and the line of sight of the driver. In this case, the vehicle display device 100 may determine a display region, a display size, and depth information of the driving information based on the distance from the external object and the line of sight of the driver, and may process and display the image including the driving information based on the determined display region, display size, and depth information.

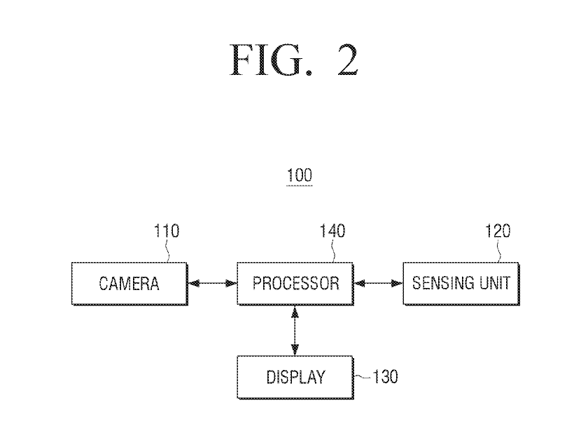

FIG. 2 is a block diagram schematically illustrating a configuration of the vehicle display device according to an embodiment of the present disclosure. As illustrated in FIG. 2, the vehicle display device 100 includes a camera 110, a sensing unit 120, a display 130, and a processor 140.

The camera 110 is installed in the vehicle system 10 to capture the driver. In particular, the camera 110 may capture eyes and a face of the driver in order to track the line of sight of the driver. In this case, the camera 110 may be implemented as a stereo camera including two cameras.

The sensing unit 120 measures the distance from the external object. Specifically, the sensing unit 120 may measure the distance from the external object by using a sensor for measuring a distance such as an infrared sensor or an ultrasonic sensor. In this case, the sensing unit 120 may include a sensor for measuring a speed of the external object.

The display 130 displays the driving information of the vehicle system 10 on the windshield of the vehicle system 10. In this case, the driving information of the vehicle system 10 may include driving information on the vehicle system 10 itself and driving information on the external object, as information (e.g., navigation, speed, fuel amount, road information, and the like) necessary for the driver to drive the vehicle system 10.

Meanwhile, the display 130 may be implemented as a three-dimensional (3D) display capable of displaying a 3D image having a 3D effect. A method of displaying the 3D image on the windshield of the vehicle system 10 will be described below in detail.

The processor 140 controls an overall operation of the vehicle display device 100. In particular, the processor 140 may analyze the image captured by the camera 110 to track the line of sight of the driver, determine the external object existing a position where the line of sight of the driver is directed, calculate the distance from the object determined by the sensing unit 120, and control the display 130 to display the driving information based on the line of sight of the driver and the distance from the object.

Specifically, the processor 140 may determine the display region of the driving information of the vehicle by using the line of sight of the driver, and determine the depth information of the driving information of the vehicle based on the distance from the object. In addition, the processor 140 may control the display 130 to render and display the driving information of the vehicle based on the determined display region and depth information. That is, the processor 140 may determine a region of the windshield where the position of the line of sight of the driver is directed as the display region. In addition, the processor 140 may determine the depth information so that the driving information is viewed in the distance, as the distance from the external object increases, and may determine the depth information so that the driving information is viewed close, as the distance from the external object decreases.

In addition, the processor 140 may control the display 130 to tilt and display the driving information of the vehicle by changing the depth information of the driving information of the vehicle based on a direction of the line of sight of the driver.

In addition, the processor 140 may determine a position of the eyes of the driver based on the captured image of the driver, and may control the display 130 to display the driving information by changing at least one of the display region and the depth information of the driving information based on the display region of vehicle information and the position of the eyes of the driver. That is, since the position of the eyes of the driver may be different from depending on a sitting height of the driver, the processor 140 may provide the driving information of the vehicle in consideration of the sitting height of the driver. Meanwhile, although it is described that the position of the eyes of the driver is determined to determine the sitting height of the driver in the embodiment described above, this is merely one example, and the sitting height of the driver may be calculated by using various information such as pre-stored information on the sitting height of the driver, a seat position, or the like.

In addition, the processor 140 may provide various types of driving information. Specifically, the processor 140 may include first driving information having fixed position and depth, second driving information in which only a depth is changed according to the distance from the object at a fixed position, and third driving information in which a position and a depth are changed a position of the line of sight and the distance from the object. In this case, the first to third driving information may be determined according to the type of the provided driving information. For example, the first driving information may be driving information of the vehicle system 10 itself, the second driving information may be driving information on an unmoving external object, and the third driving information may be driving information on a moving external object.

In addition, the processor 140 may determine a motion of the eyes and face of the driver by analyzing of the captured image of the driver, and may obtain direction information of the line of sight of the driver when the determined motion is continued for a predetermined time or more. That is, if the driving information moves even in the case of a small movement of the driver, the driver not only feels dizziness but also may take time to focus. Therefore, only in the case in which the processor 140 detects the motion for the predetermined time or more, the processor 140 may obtain the direction information of the line of sight of the driver and determine the display region and the depth information of the driving information.

In addition, the processor 140 may determine an object positioned within a predetermined angle range based on the direction information of the line of sight of the driver. That is, the processor 140 may reduce an amount of calculation by determining only an object within a predetermined angle range that the driver is actually looking at based on the line of sight of the driver.

In addition, the processor 140 may obtain information on the determined object, and may control the display 130 to determine and display the obtained information on the object as the driving information of the vehicle. Specifically, the processor 140 may obtain the information on the object from an external server, obtain the information on the object by searching for pre-stored information, and obtain the information on the object based on a sensed value detected by the sensing unit 120.

Meanwhile, although it is described that the depth information of the driving information of the vehicle is determined based on the distance from the object in the embodiment described above, this is merely one example, and the display size of the driving information of the vehicle may be determined based on the distance from the object. Specifically, the processor 140 may determine the display region of the driving information of the vehicle by using the line of sight of the driver, determine the display size of the driving information of the vehicle based on the distance from the object, and control the display 130 to render and display the driving information of the vehicle based on the determined display region and display size.

According to various embodiments of the present disclosure as described above, not only the driver may confirm the driving information safely, but also sensitivity to motion sickness may be reduced. In addition, the driver may obtain necessary information on the object the driver is looking at.

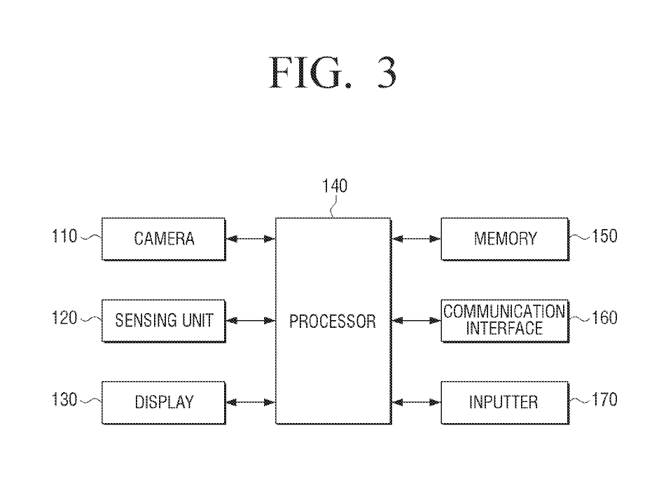

FIG. 3 is a block diagram illustrating the configuration of the vehicle display device 100 according to an embodiment of the present disclosure in detail. As illustrated in FIG. 3, the vehicle display device 100 includes the camera 110, the sensing unit 120, the display 130, a memory 150, a communication interface 160, an inputter 170, and the processor 140. Meanwhile, the configuration illustrated in FIG. 3 is merely one example, and depending on implementation, new components may be added and at least one component may be removed.

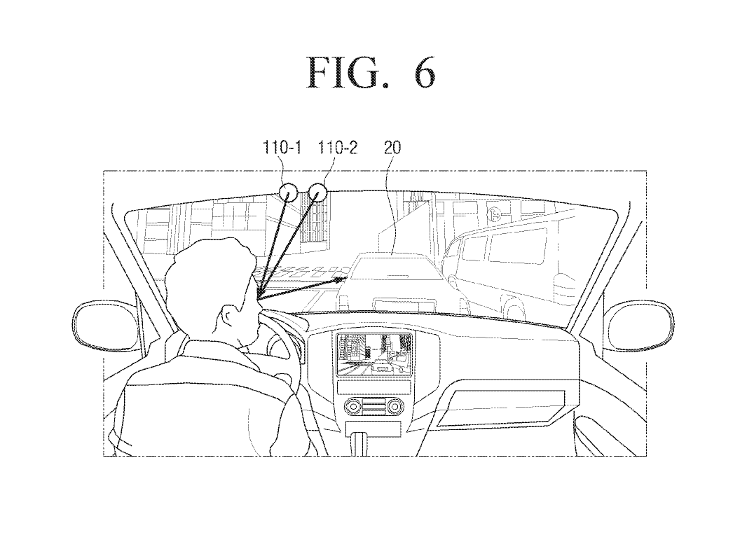

The camera 110 is disposed in the vehicle system 10 to capture the driver. In particular, the camera 110 may capture an upper body, a face and eyes of the driver in order to track the line of sight of the driver. In particular, the camera 110 may be disposed at an upper end portion of the windshield of the vehicle system 10 as illustrated in FIG. 6, and may be a stereo-type camera including two cameras 110-1 and 110-2.

Meanwhile, the camera 110 is disposed at the upper end portion of the windshield of the vehicle system 10 only by way of example and may be disposed on another area such as a dashboard of the vehicle or the like. In addition, the camera 110 may be a general camera for capturing color images, but this is merely an example and may be an infrared camera.

The sensing unit 120 is a component for measuring the distance from the external object. In particular, the sensing unit 120 may measure the distance from the external object by using an infrared sensor or an ultrasonic sensor. Specifically, in a case in which the sensing unit 120 includes the infrared sensor, the infrared sensor may transmit infrared rays and receive reflected infrared rays. In addition, the processor 140 may measure the distance by using a phase difference between the transmitted infrared rays and the reflected infrared rays. In addition, in a case in which the sensing unit 120 includes the ultrasonic sensor, the ultrasonic sensor may transmit ultrasonic waves and receive reflected ultrasonic waves. In addition, the processor 140 may measure the distance by using a difference between a transmission time and a reception time. For example, when the difference between the transmission time and the reception time is 0.1 seconds, the processor 140 may calculate the distance from the external object as 17 m in consideration of a speed (340 m/s) of sound.

Meanwhile, the sensing unit 120 may include a sensor (e.g., a speed measuring sensor, a camera, or the like) for obtaining information (e.g., a speed, contents of a sign, and the like) on the external object.

The display 130 may display the driving information on the windshield of the vehicle system 110. In this case, the display 130 may be a head up display. The head up display is a display capable of providing the driving information to the front of the driver, that is, an area (e.g., the windshield of the vehicle, or the like) which does not deviate from a main line of sight of the driver during driving of the vehicle or aircraft. The head up display may be implemented in various types such as a transparent display type, a projection type, a direct reflection type, and the like. The transparent display type is a type of displaying an image using a transparent display panel, the projection type is a type that a light source projects the image onto the windshield, and the direct reflection type is a type of reflecting an image displayed on a separate display to the windshield.

In particular, the display 130 may be implemented as a three-dimensional (3D) display for displaying a 3D image having a 3D effect. In particular, the display 130 may be a 3D display of a glassless type in which the driver does not need to wear glasses to view 3D images.

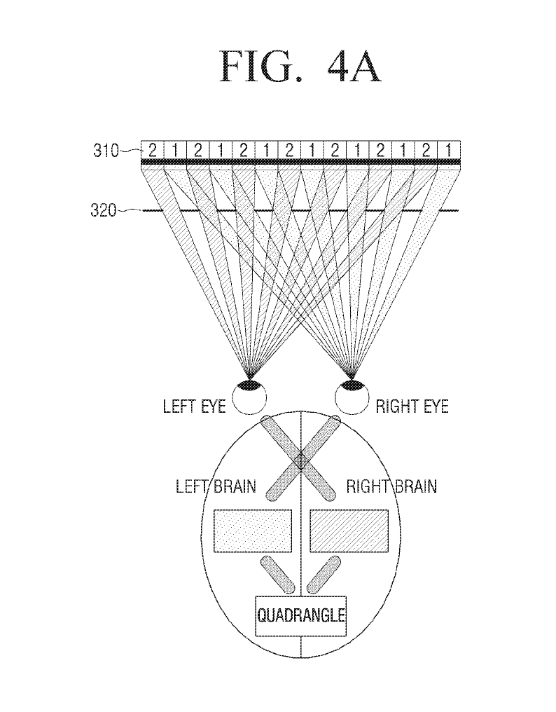

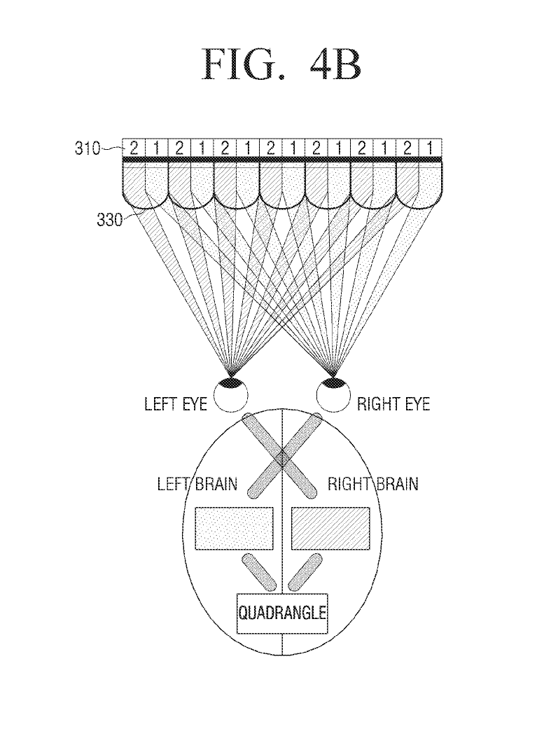

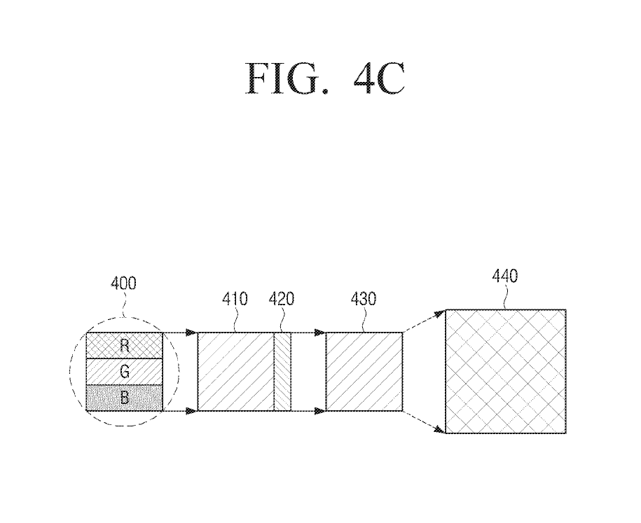

FIGS. 4A and 4B are diagrams for describing an operation of the 3D display of the glassless type for facilitating understanding of the present disclosure.

FIGS. 4A and 4B illustrate an operation method of a device for displaying a multi-view image and providing a stereoscopic image in the glassless type according to an embodiment of the present disclosure, in which the multi-view image includes a plurality of images obtained by capturing the same object at different angles. That is, a plurality of images captured at different viewpoints are refracted at different angles, and an image focused to a position (e.g., about 3 meters) away from a predetermined distance called a viewing distance is provided. The position where such an image is formed is called a viewing area (or an optical view). Accordingly, when one eye of the driver is located in a first viewing area and the other eye is located in a second viewing area, the driver may feel a three-dimensional effect.

As an example, FIGS. 4A and 4B are diagrams for describing a display operation of the multi-view image of two view points in total. According to FIGS. 4A and 4B, the 3D display of the glassless type may display the multi-view image of the two view points on a display panel 310, and a parallax barrier 320 (FIG. 4A) or the lenticular lens 330 (FIG. 1B) may project light corresponding to one view point image of the two view points on the left eye of the driver, and project light corresponding to the image of the two view points on the right eye of the driver. Accordingly, the driver may view images of different view points in the left and right eyes and feel the three-dimensional effect.

FIG. 4C is a diagram for describing an example in which the 3D display of the glassless type according to an embodiment of the present disclosure is applied to the vehicle display device. As illustrated in FIG. 4C, the 3D display of the glassless type includes a light source 400, a display panel 410, a stereoscopic image filter 420, and a virtual image optical system 430.

The light source 400 generates lights of red, green, and blue. In addition, the display panel 410 reflects or transmits the light generated by the light source 400 to generate an image including a variety of driving information required actually by the driver. The stereoscopic image filter 420 may separate a viewing zone so that the driver may feel the 3D effect of the reflected or transmitted image. The virtual image optical system 430 may display an image obtained through the stereoscopic image filter 420 on the windshield of the vehicle as a virtual 3D image 440.

In this case, the light source 400 may use a UHP lamp, an LED, a laser, or the like as an illumination light source, and the display panel 410 may be implemented as an LCD, an LOCS, or an MDM. In addition, the stereoscopic image filter 420 may be implemented by a lenticular lens or a parallax barrier, and the virtual image optical system 430 may be implemented by a mirror and a combiner.

Meanwhile, it is described that the 3D display of the glassless type provides the 3D image in the embodiment described above, but this is merely one example and the 3D image may be provided by using a varying focal lens. In this case, the display 130 may adjust the depth by changing a focal length of the lens by an external current.

Referring to again FIG. 3, the memory 150 may store instructions or data received from the processor 140 or other components (e.g., the camera 110, the sensing unit 120, the display 130, the communication interface 160, the inputter 170, and the like), or generated by the processor 140 or other components. In addition, the memory 150 may include programming modules such as, for example, a kernel, middleware, application programming interface (API), or application. Each of the programming modules described above may be constituted by software, firmware, hardware, or a combination of two or more thereof.

In addition, the memory 150 may store the various driving information. For example, the memory 150 may store navigation information such as road information, sign information, and the like as well as information on the vehicle (including an external vehicle as well as a vehicle equipped with the vehicle display device 100).

Meanwhile, the memory 150 may be implemented in various memories. For example, the memory may be implemented as an internal memory. The internal memory may include at least one of, for example, a volatile memory (for example, a dynamic random access memory (DRAM), a static RAM (SRAM), a synchronous dynamic RAM (SDRAM), or the like), or a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, a flash ROM, a NAND flash memory, a NOR flash memory, or the like). According to one embodiment, the internal memory may also take a form of a solid state drive (SSD). In addition, the memory 150 may be implemented as an external memory. The external memory may further include a flash drive, for example, a compact flash (CF), a secure digital (SD), a micro secure digital (Micro-SD), a mini secure digital (Mini-SD), an extreme digital (xD), a memory stick, or the like.

The communication interface 160 may perform communication with an external server or the vehicle system 10. Specifically, the communication interface 160 may obtain various driving information (e.g., navigation information, accident information, and the like) from the external server. In addition, the communication interface 160 may also communicate with internal configurations of the vehicle system 10 to transmit and receive vehicle control information.

Meanwhile, the communication interface 160 may support a predetermined short-range communication protocol (e.g., wireless fidelity (Wifi), Bluetooth (BT), near field communication (NFC)), a predetermined network communication (e.g., Internet, local area network (LAN), wire area network (WAN), telecommunication network, cellular network, satellite network, or plain old telephone service)), or the like.

The inputter 170 receives driver commands for controlling the vehicle display device 100. In this case, the inputter 170 may be implemented as an input device capable of safely inputting the driver commands during driving of the vehicle such as a pointing device or a voice inputter, but this is merely one example and may be implemented as other input devices (e.g., a touch screen and the like).

In particular, the inputter 170 may receive driver commands for controlling the vehicle display device 100 or the vehicle system 10.

The processor 140 may receive the commands from other commands through a component such as a bus (not illustrated) to decode the received commands and execute an operation or a data processing according to the decoded command.

In addition, the processor 140 may include a main processor and a sub-processor, and the sub-processor may be constituted by a low-power processor. In this case, the main processor and the sub-processor may be implemented in the form of one chip, and may be implemented in separate chips. In addition, the sub-processor may include a memory of a type of a buffer or stack therein.

Meanwhile, the processor 140 may be implemented as at least one of a graphic processing unit (GPU), a central processing unit (CPU), or an application processor (AP), and may also be implemented in one chip.

In particular, the processor 140 may analyze the image captured by the camera 110 to track the line of sight of the driver, determine the external object existing a position where the line of sight of the driver is directed, calculate the distance from the object determined by the sensing unit 120, and control the display 130 to display the driving information based on the line of sight of the driver and the distance from the object.

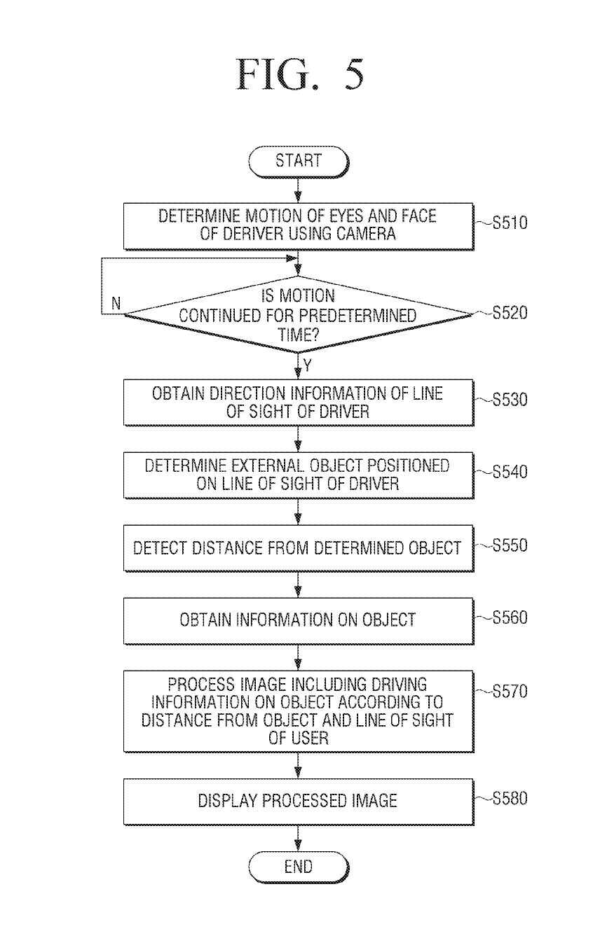

FIG. 5 is a flowchart for describing a control method of a vehicle display device 100 according to an embodiment of the present disclosure in detail.

First, the processor 140 determines a motion of the eyes and the face of the driver using the camera 110 (S510). Specifically, the processor 140 may analyze the image captured by the camera to recognize a pupil and the face of the driver, and determine a motion of the recognized pupil and a motion of the face. In this case, the camera 110 may be disposed at an upper end portion of the windshield of the vehicle system 10, as illustrated in FIG. 6.

In addition, the processor 140 determines whether or not the motion of at least one of the pupil or the face has continued for a predetermined time (S520). That is, the processor 140 may ignore the motion within the predetermined time. This is because, when the driving information is changed for the motion within the predetermined time, the display position or the depth of the driving information is changed so that the driver may feel sensitivity to motion sickness and possibility of the accident may increase. Meanwhile, the processor 140 may determine the time at which at least one of the pupil or the face moves, but this is merely one example, and may determine a size in which at least one of the pupil or the face moves.

If the motion of at least one of the pupil or the face is continued for the predetermined time (Yes in S520), the processor 140 obtains direction information of the line of sight of the driver (S530). Specifically, the processor 140 may obtain information on a direction in which the driver is looking at after at least one of the eyes or the face of the driver moves for the predetermined time or more.

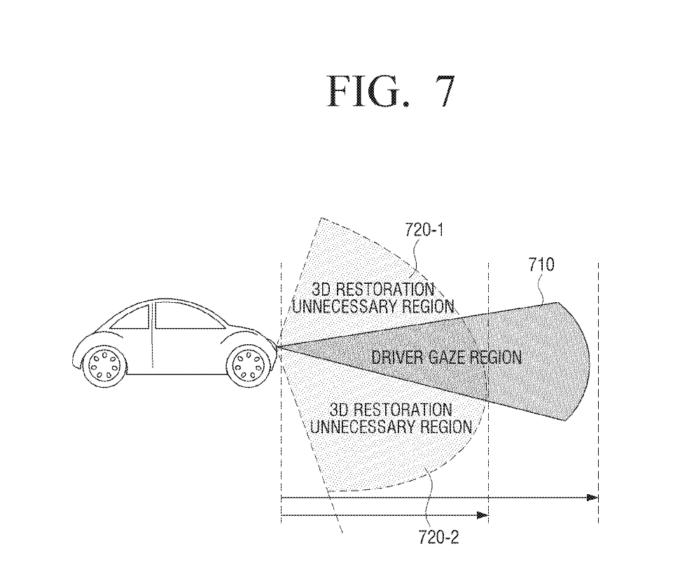

In addition, the processor 140 may determine an external object positioned on the line of sight of the driver (S540). Specifically, the processor 140 may determine at least one object positioned within a predetermined range based on the direction information of the line of sight of the driver. For example, the processor 140 may determine an object positioned in a region 710 within the predetermined range corresponding to the direction in which the line of sight of the driver is directed, as illustrated in FIG. 7. In this case, the processor 140 may ignore objects positioned in regions 720-1 and 720-2 other than the predetermined range.

In particular, the processor 140 may recognize the object positioned in the region 710 within the predetermined range. For example, the processor 140 may capture the object positioned within the region 710 through the camera provided outside the vehicle system 10, and recognize the captured object to determine a type of the object. For example, the processor 140 may determine that the type of the object positioned within the region 710 is one of an automobile, a bicycle, a sign, a traffic light, or a person.

In addition, the processor 140 detects a distance from the determined object (S550). Specifically, the processor 140 may determine distances from objects positioned in the region 710 within the predetermined range through the sensing unit 120. In this case, the processor 140 may detect a speed as well as the determined distance from the object.

In addition, the processor 140 obtains information on the object (S560). In this case, the processor 140 may obtain the information on the object from an external server, obtain the information on the object by searching for pre-stored information, and obtain the information on the object based on the information detected by the sensing unit 120. For example, when it is determined that the vehicle is stopped within the region 710, the processor 140 may control the communication interface 160 to receive driving information (e.g., accident information) on the stopped vehicle from the external server. As another example, when it is determined that a sign is present within the region 710, the processor 140 may search for and obtain driving information corresponding to the sign among the navigation information stored in the memory 150. As another example, when it is determined that a moving vehicle exists within the region 710, the processor 140 may obtain a distance from the vehicle and a speed of the vehicle through the sensing unit 120.

In addition, the processor 140 processes an image including the driving information on the object according to the distance from the object and the line of sight (S570). Here, the driving information may be driving information of the vehicle system 10 itself, and may be driving information on the external object.

Specifically, the processor 140 may determine a display region of the driving information of the vehicle by using the line of sight of the driver, determine depth information of the driving information of the vehicle based on the distance from the object, and control the display 130 to display the driving information of the vehicle based on the determined display region and depth information.

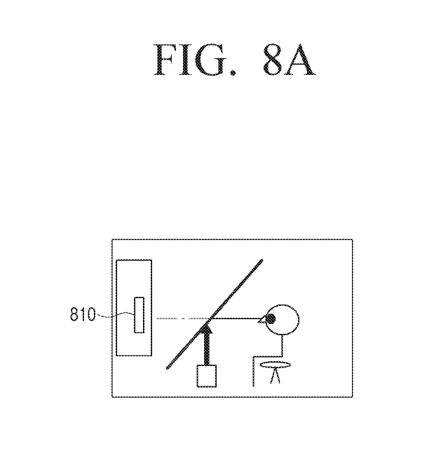

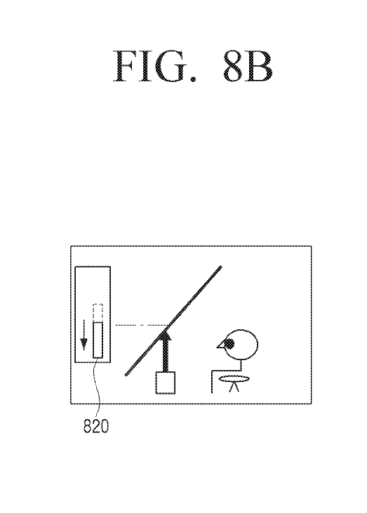

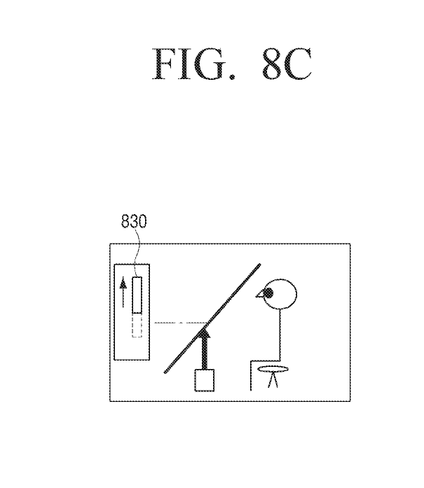

More specifically, the processor 140 may determine a region to which the line of sight of the driver is directed as the display region of the driving information of the vehicle. For example, as illustrated in FIG. 8A, when the line of sight of the driver is positioned in a middle region of the windshield, the processor 140 may control the display 130 to display the driving information 810 on the middle region of the windshield so as to correspond to the direction to which the line of sight of the driver is directed. As another example, as illustrated in FIG. 8B, when the line of sight of the driver is positioned in a lower end region of the windshield, the processor 140 may control the display 130 to display the driving information 820 on the lower end region of the windshield so as to correspond to the direction to which the line of sight of the driver is directed. As another example, as illustrated in FIG. 8C, when the line of sight of the driver is positioned in an upper end region of the windshield, the processor 140 may control the display 130 to display the driving information 830 on the upper end region of the windshield so as to correspond to the direction to which the line of sight of the driver is directed.

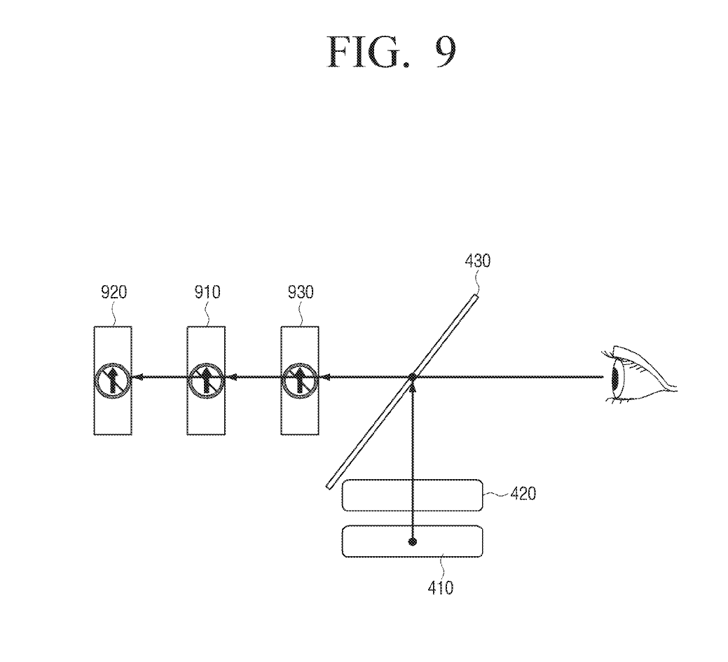

In addition, the processor 140 may determine the depth information of the driving information based on the distance from the external object. Specifically, the processor 140 may determine to increase a depth value as the distance from the external object increases, and determine to decrease the depth value as the distance from the external object decreases. In this case, as the depth value is larger, the driving information may be displayed as if it is far away, and as the depth value is smaller, the driving information may be displayed as if it is nearby. For example, when the distance from the external object is a first distance, the processor 140 may control the display 130 to display driving information 910 having a first depth value, as illustrated in FIG. 9. In addition, when the distance from the external object is a second distance which is greater than the first distance, the processor 140 may control the display 130 to display driving information 920 having a second depth value which is greater than the first depth value, as illustrated in FIG. 9. In addition, when the distance from the external object is a third distance which is smaller than the first distance, the processor 140 may control the display 130 to display driving information 930 having a third depth value which is smaller than the first depth value, as illustrated in FIG. 9. In this case, the processor 140 may process a multi-view 3D image based on the determined depth value to provide the driving information 930 having a depth corresponding to the distance from the external object.

That is, the processor 140 may reduce sensitivity to motion sickness of the driver by adjusting the depth value of the driving information so as to correspond to the distance from the object to which the line of sight of the driver is directed.

In addition, the processor 140 may control the display 130 to tilt and display the driving information of the vehicle by changing the depth information of the driving information of the vehicle based on a direction of the line of sight of the driver.

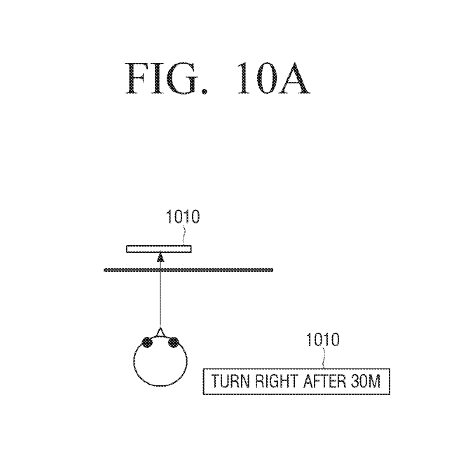

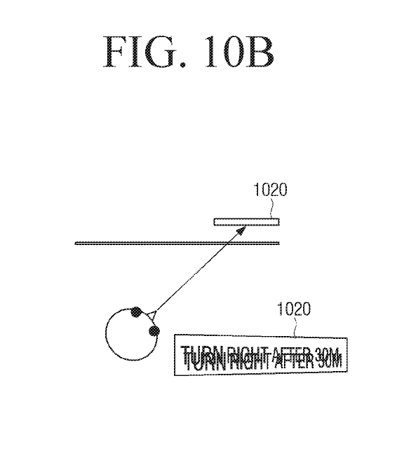

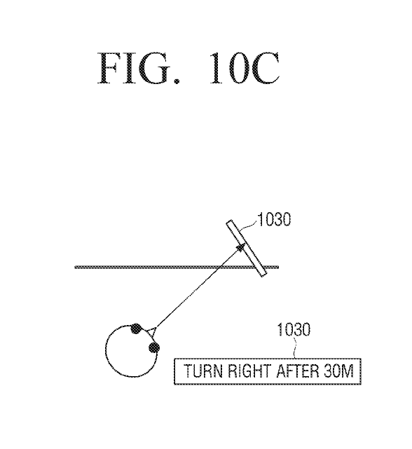

Specifically, when the line of sight of the driver is directed to the front as illustrated on the left side of FIG. 10A, the processor 140 displays driving information 1010 on the front of the driver so that the driving information 1010 may be seen clearly as illustrated on the right side of FIG. 10A.

However, as illustrated on the left side of FIG. 10B, when driving information 1020 is provided to be directed to the front in a case in which the direction of the line of sight of the driver is changed (i.e., the driver looks to the right side), crosstalk and image distortion occur in the driving information 1020 as illustrated on the right side of FIG. 10B.

Therefore, as illustrated on the left side of FIG. 10C, when the direction of the line of sight of the driver is changed, the processor 140 may change the depth information of driving information 1030 and control the display 130 to tilt an display the driving information 1030. That is, the processor 140 may determine the depth information so that the right side of the driving information 1030 is positioned far away, determine the depth information so that the left side of the driving information 1030 is positioned near, and control the display 130 to tilt and display the driving information 1030 based on the determined depth information. Thereby, as illustrated on the right side of FIG. 10C, the driving information 1020 may be viewed clearly.

As another example of the present disclosure, the processor 140 may determine a position of the eyes of the driver based on the captured image of the driver, and may control the display 130 to display the driving information by changing the depth information based on the display region of vehicle information and the position of the eyes of the driver.

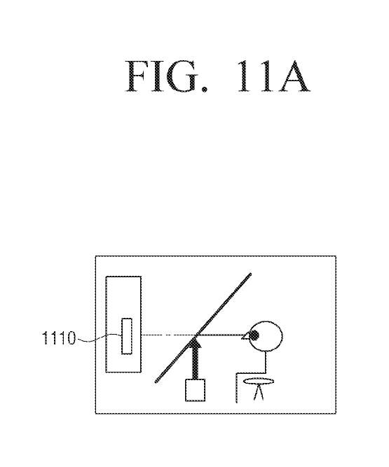

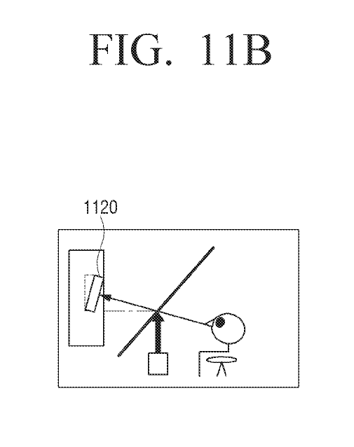

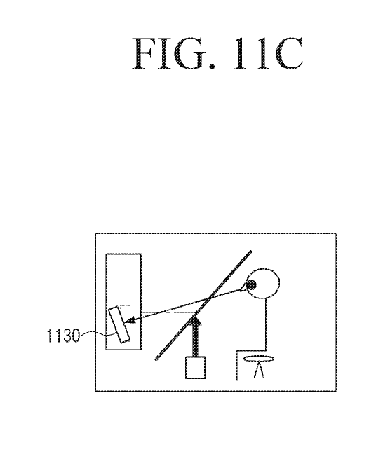

For example, when a position of the eyes of a user is at a middle and the line of sight of the driver is directed to a middle region of the windshield as illustrated in FIG. 11A, the processor 140 may control the display 130 to display the driving information 1110 on the middle region of the windshield to which the line of sight of the driver is directed.

However, when the position of the eyes of the user is below and the line of sight of the driver is directed upwardly as illustrated in FIG. 11B, the processor 140 may change depth information of driving information 1120 displayed on the upper end region of the windshield and control the display 130 to tilt and display the driving information 1120. That is, the processor 140 may determine the depth information so that the upper side of the driving information 1120 is positioned nearby, determine the depth information so that the lower side of the driving information 1120 is positioned far away, and control the display 130 to tilt and display the driving information 1120 based on the determined depth information.

In addition, when the position of the eyes of the user is above and the line of sight of the driver is directed downwardly as illustrated in FIG. 11C, the processor 140 may change depth information of driving information 1130 displayed on the lower end region of the windshield and control the display 130 to tilt and display the driving information 1130. That is, the processor 140 may determine the depth information so that the lower side of the driving information 1130 is positioned nearby, determine the depth information so that the upper side of the driving information 1130 is positioned far away, and control the display 130 to tilt and display the driving information 1130 based on the determined depth information.

Referring to again FIG. 5, the display 130 displays an image including the driving information of the vehicle (S580).

Meanwhile, according to an embodiment of the present disclosure, the driving information of the vehicle may include a plurality of types having different display schemes. Specifically, the driving information of the vehicle may include first driving information having fixed position and depth, second driving information in which only a depth is changed according to the distance from the object at a fixed position, and third driving information in which a position and a depth are changed a position of the line of sight and the distance from the object.

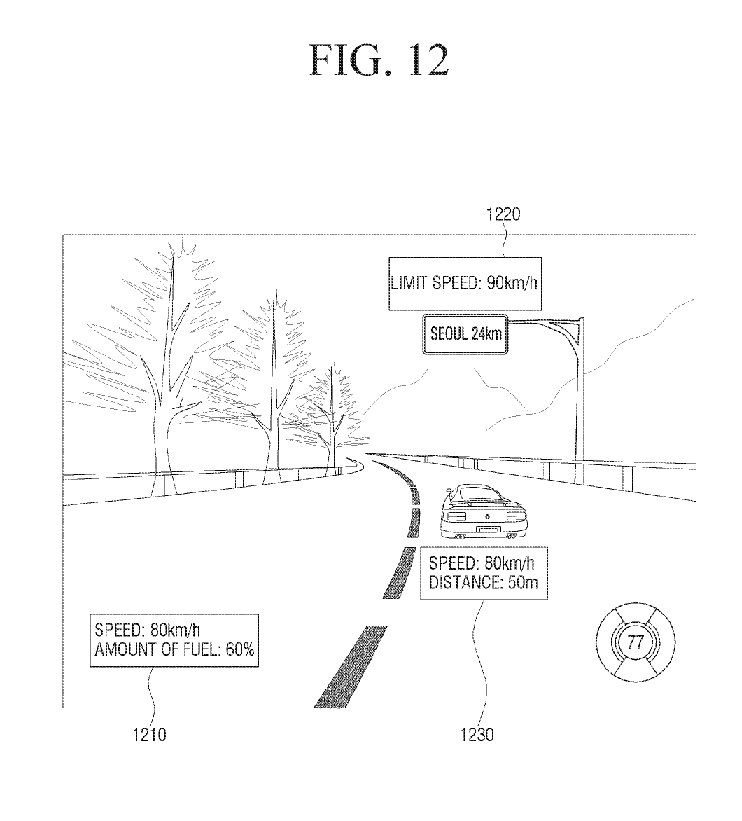

For example, the processor 140 may perform a process so that driving information 1210 on the vehicle system 10 itself such as a speed, an amount of fuel, and the like of the vehicle system 10 has a fixed position and depth, as illustrated in FIG. 12. In addition, the processor 140 may perform a process so that only a depth of driving information 1220 on an external fixed object (e.g., a sign, a traffic light, a speed bump, or the like) is changed depending on the distance from the object at a fixed position. In addition, the processor 140 may perform a process so that a position and a depth of driving information 1230 on an external moving object (e.g., an automobile, a person, or the like) are changed depending on a position of the line of sight and the distance from the object.

That is, the processor 140 may recognize the external object and then provide the driving information in different display schemes according to the type of the recognized external object.

According to an embodiment of the present disclosure, when the processor 140 obtains information on the external object, the processor 140 may control the display 130 to determine and display the obtained information on the object as the driving information of the vehicle. In this case, the processor 140 may control the display 130 to display the driving information in the vicinity of the external object. For example, in a case in which the external object is an automobile, when the processor 140 obtains information on a distance from the automobile and a speed of the automobile, the processor 140 may control the display 130 to display driving information on the distance from the automobile and the speed of the automobile in the vicinity of the automobile.

Meanwhile, although it is described that the depth of the driving information is adjusted according to the distance from the external object in the embodiment described above, this is merely one example, and a display size of the driving information may be adjusted according to the distance from the external object. Specifically, the processor 140 may determine the display region of the driving information of the vehicle by using the line of sight of the driver, determine the display size of the driving information of the vehicle based on the distance from the object, and control the display 130 to display the driving information of the vehicle based on the determined display region and display size.

As described above, by displaying the information on the object that the driver is looking at as the position and the depth at which the sight of the driver stays according to the sight line of the driver and the distance from the external object, the driver may not only confirm the driving information safely, but also the sensitivity to motion sickness may be reduced. In addition, the driver may obtain necessary information on the object the driver is looking at.

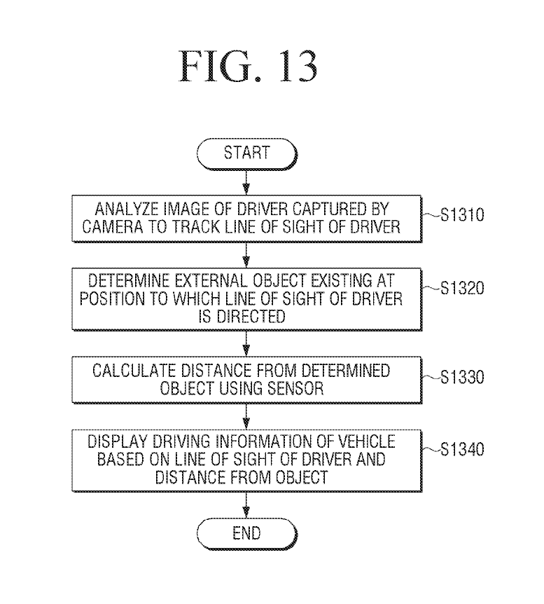

FIG. 13 is a flow chart for describing a control method of a vehicle display device 100 according to an embodiment of the present disclosure.

First, the vehicle display device 100 analyzes the image of the driver captured by the camera 110 to track the line of sight of the driver (S1310).

In addition, the vehicle display device 100 determines an external object existing at a position to which the line of sight of the driver is directed (S1320). In this case, the vehicle display device 100 may obtain information on the external object existing at the position to which the line of sight of the driver is directed.

In addition, the vehicle display device 100 calculates a distance from the determined object using a sensor (e.g., an ultrasonic sensor or the like) (S1330).

In addition, the vehicle display device 100 displays driving information of the vehicle based on the line of sight of the driver and the distance from the object (S1340). Specifically, the vehicle display device 100 may determine a display region and depth information of the driving information based on the line of sight of the driver and the distance from the object, and display the driving information based on the determined display region and depth information.

Meanwhile, according to an embodiment of the present disclosure, a mode of providing the driving information based on the line of sight of the driver and the distance from the object may be referred to as a head-up display (HUD) mode. That is, when a mode of the vehicle display device 100 is the HUD mode, the processor 140 may determine the display position and the depth information of the driving information based on the line of sight of the driver and the distance from the object, and control the display 130 to display the driving information. However, by a user setting, or in a case in which it is difficult for the HUD mode to normally operate (e.g., the camera or sensor fails, and a predetermined number of objects or more exist within a range of the line of sight of the user), the processor 140 may switch the mode of the vehicle display device 100 into a general mode to provide 2D type driving information that does not the 3D effect to the predetermined region. In this case, the 2D type driving information may include only basic information such as the speed, the amount of fuel or the like of the vehicle. That is, when the HUD mode is abnormally operated, the field of view of the user is disturbed, which may become a threat to safe driving, and the processor 140 may thus switch the mode of the vehicle display device 100 into the general mode to provide the safe driving to the user.

Meanwhile, although the present disclosure is disclosed in various flow charts in a specific order, it is merely one example, and the embodiments of the present disclosure may be implemented by other methods. For example, in other embodiments, the order may be reversed, specific orders may be combined, or specific orders may be overlapped.

In addition, the embodiments and all functional operations described herein may be implemented within digital electronic circuitry or in computer software, firmware, or hardware, including structures disclosed herein and their equivalents, or one or more combinations thereof.

A computer readable medium may be any available media that may be accessed by a computer, and includes both volatile and nonvolatile media, and removable and non-removable media. In addition, the computer readable medium may include both a computer storage medium and a communication medium. The computer storage medium includes both volatile and nonvolatile media, and removable and non-removable media implemented in any method or technology for storage of information such as computer readable instructions, data structures, program modules or other data. The communication medium typically includes computer readable instructions, data structures, program modules, or other data or other transport mechanism in a modulated data signal such as a carrier wave, and include any information delivery medium.

It will be understood by those skilled in the art that the foregoing description of the present disclosure is for illustrative purposes only and that those skill in the art may readily understand that various changes and modifications may be made without departing from the spirit or essential characteristics of the present disclosure. Therefore, it is to be understood that the embodiments described hereinabove are illustrative rather than being restrictive in all aspects. It is to be understood that the scope of the present disclosure will be defined by the claims rather than the above-mentioned description and all modifications and alternations derived from the claims and their equivalents are included in the scope of the present disclosure.

1. A vehicle display device comprising:
a camera configured to capture a driver;
a sensing unit configured to measure a distance from an external object;
a display configured to provide driving information of a vehicle; and
a processor configured to analyze an image captured by the camera to track a line of sight of the driver, determine the external object existing at a position to which the tracked line of sight of the driver is directed, calculate a distance from the determined object using the sensing unit, and control the display to display the driving information based on the line of sight of the driver and the distance from the object.

2. The vehicle display device as claimed in claim 1, wherein the display is a three-dimensional (3D) display of displaying a 3D image, and
the processor determines a display region of the driving information of the vehicle using the line of sight of the driver, determines depth information of the driving information of the vehicle based on the distance from the object, and controls the display to display the driving information of the vehicle based on the determined display region and depth information.

3. The vehicle display device as claimed in claim 1, wherein the processor controls the display to tilt and display the driving information of the vehicle by changing the depth information of the driving information of the vehicle based on a direction of the line of sight of the driver.

4. The vehicle display device as claimed in claim 2, wherein the processor determines a position of eyes of the driver based on the captured image of the driver, and controls the display to display the driving information of the vehicle by changing at least one of the display region or the depth information of the driving information based on the display region of the information of the vehicle and the position of the eyes of the driver.

5. The vehicle display device as claimed in claim 1, wherein the driving information of the vehicle includes first driving information having fixed position and depth, second driving information in which only a depth is changed according to the distance from the object at a fixed position, and third driving information in which a position and a depth are changed according a position of the line of sight and the distance from the object.

6. The vehicle display device as claimed in claim 1, wherein the processor analyzes an image of the captured driver to determine a motion of eyes and a face of the driver, and obtains direction information of the line of sight of the driver when the determined motion is continued for a predetermined time or more.

7. The vehicle display device as claimed in claim 6, wherein the processor determines an object positioned within a predetermined angle range based on the direction information of the line of sight of the driver.

8. The vehicle display device as claimed in claim 1, wherein the processor obtains information on the determined object, and controls the display to determine and display the obtained information on the object as the driving information of the vehicle.

9. The vehicle display device as claimed in claim 1, wherein the processor determines a display region of the driving information of the vehicle using the line of sight of the driver, determines a display size of the driving information of the vehicle based on the distance from the object, and controls the display to display the driving information of the vehicle based on the determined display region and display size.

10. A control method of a vehicle display device, the control method comprising:
analyzing an image captured by the camera and tracking a line of sight of the driver;
determining an external object existing at a position to which the line of sight of the driver is directed;
calculating a distance from the determined object using a sensor; and
displaying driving information of a vehicle based on the line of sight of the driver and the distance from the object.

11. The control method as claimed in claim 10, wherein the vehicle display device includes a display of displaying a three-dimensional (3D) image, and
in the displaying of the driving information, a display region of the driving information of the vehicle is determined using the line of sight of the driver, depth information of the driving information of the vehicle is determined based on the distance from the object, and the driving information of the vehicle is displayed based on the determined display region and depth information.

12. The control method as claimed in claim 10, wherein in the displaying of the driving information, the driving information of the vehicle is tilted and displayed by changing the depth information of the driving information of the vehicle based on a direction of the line of sight of the driver.

13. The control method as claimed in claim 11, further comprising determining a position of eyes of the driver,
wherein in the displaying of the driving information, the driving information of the vehicle is displayed by changing at least one of the display region or the depth information of the driving information based on the display region of the information of the vehicle and the position of the eyes of the driver.

14. The control method as claimed in claim 10, wherein the driving information of the vehicle includes first driving information having fixed position and depth, second driving information in which only a depth is changed according to the distance from the object at a fixed position, and third driving information in which a position and a depth are changed a position of the line of sight and the distance from the object.

15. The control method as claimed in claim 10, wherein the tracking of the line of sight of the driver includes:
capturing an image of the driver using the camera;
determining a motion of eyes and a face of the driver by analyzing the captured image of the driver; and
when the determined motion is continued for a predetermined time or more, obtaining direction information of the line of sight of the driver.
